(19) United States
(12) Patent Application Publication
(10) Pub. No.: US 2013/0188342 A1
(43) Pub. Date: Jul. 25, 2013

(54) LAMP STRUCTURE

(71) Applicant: Ming-Kuei LIN, Panchiao City (TW)

(72) Inventor: Ming-Kuei LIN, Panchiao City (TW)

(21) Appl. No.: 13/357,290

(22) Filed: Jan. 24, 2012

(51) Int. Cl. F21L 4/00; F21V 15/00

(52) U.S. Cl. 362/186; 362/363

(57) ABSTRACT

A lamp body comprises a PCB with electronic control circuits; wherein the body comprising at least one light illuminating element on the PCB; a lamp shade, which comprises at least one lamp housing for the illuminating element; a switch, which is installed in the said lamp body; and one control structure, comprising a pressing plate, which is pivotally installed in the lamp body and is in conjunction with the switch, therein one end of the said pressing plate is connected with the lamp body via a flexible spring object, and the other end is connected with a strap; thereby the said strap being pulled outwardly and subsequently the pressing plate being rotated forward pivotally thereafter activating the said switch, which selecting the on-off and illuminating modes of the light illuminating element.

### BACKGROUND OF THE INVENTION

This present invention relates to a lamp structure, which comprises lamp body, lamp shade, illuminating element, switch, control structure, and strap. The areas of the invention are in the mechanical structure and the related operation with emphasis on structural simplification and functional diversity.

The invention presents a lamp body, particularly relates to a pulling operation of a pulled object thereby subsequently causing a leveling action of a pressing plate and activating a switch for controlling turn-on, turn-off, or twinkling status of the said lamp body.

The lamp bodies of the prior arts widely comprise the LED's (Light Emitting Diodes) as the illuminating element due to LED features such as low power consumption, long life time, small size, fast response time etc.

Generally an LED lamp mainly comprises a lamp body and an attached lamp shade covering the lamp body, which comprising a power source component for connecting to the external power supply at bottom portion and for securing the power line onto a lamp base, thereon installed a switch for operationally controlling the on-and-off status, however, the drawback of this design approach is that the lamp body of LED and the lamp base are assembled thereby into a lamp structure, which is large in size, heavier, and inconvenient to operate, moreover, the manufacturing procedure for LED lamp body and lamp base is rather complicated, consequently the cost increases as the part number is comparable numerous to the traditional ones.

### SUMMARY OF THE INVENTION

The prime purpose of this invention is to provide a lamp structure, which not only reducing the number of components for building the said lamp structure, simplifying the steps of manufacture process, and saving the cost of manufacture equipments, but also making the operation of lamp structure more convenient.

Hereby, the lamp structure comprises a lamp body, which comprising an internal cavity connected with an opening on the top, a perforated hole at bottom for external connections, and a PCB (Printed Circuit Board) attached firmly on the wall of the internal cavity near the said opening; at least an illuminating element, which is installed on the PCB and electrically connected with the PCB, therein a power source providing the electrical power for emitting light of the said illuminating element; a lamp shade, which comprises an opening at bottom, at least one lamp housing for illuminating element, thereof the opening coupling with the opening on the top of the lamp body; a switch, which is installed inside the internal cavity of the lamp body, and electrically connected with at least one illuminating element for selecting the on-off and illuminating modes of the light illuminating element; and a control structure, which comprises a pressing plate installed in the internal cavity of the lamp body in conjunction with the said switch, therein one end defined as the first termination, and the opposing end defined as the second termination, therein comprising a pivotal axis between the first and second terminations such that the pressing plate installed pivotally inside the lamp body; a spring object, which connects with the first termination at one end, and the other end flexibly secured inside the internal cavity of the lamp body; and a strap, which comprises a fixed end connected with the second termination of the pressing plate, and the opposing other end comprising a loose end extending through the perforated hole to the outside of the lamp body; thereof when the strap is pulled outward referring to the lamp body, subsequently the pressing plate rotated pivotally around the pivotal axis clockwise, thereafter contacting the switch and selecting the on-off and illuminating modes of the light illuminating element; thereof the strap is released, the recoil of the spring object making the pressing plate rotated counterclockwise and separating with the switch.

### BRIEF DESCRIPTION OF THE DRAWINGS

FIG. 1 is a perspective view of the invented lamp structure.

FIG. 2 is an assembly view of the key components of the invented lamp structure.

FIG. 3 is a front view of the invented lamp structure.

FIG. 4 is a cross section view of the invented lamp structure along cross-sectioning line “4-4” as shown in FIG. 1.

FIG. 5 showing the pressing plate contacting the switch as shown in FIG. 4.

FIG. 6 showing the pressing plate separating the switch as shown in FIG. 4.

### DETAILED DESCRIPTION OF THE PREFERRED EMBODIMENT

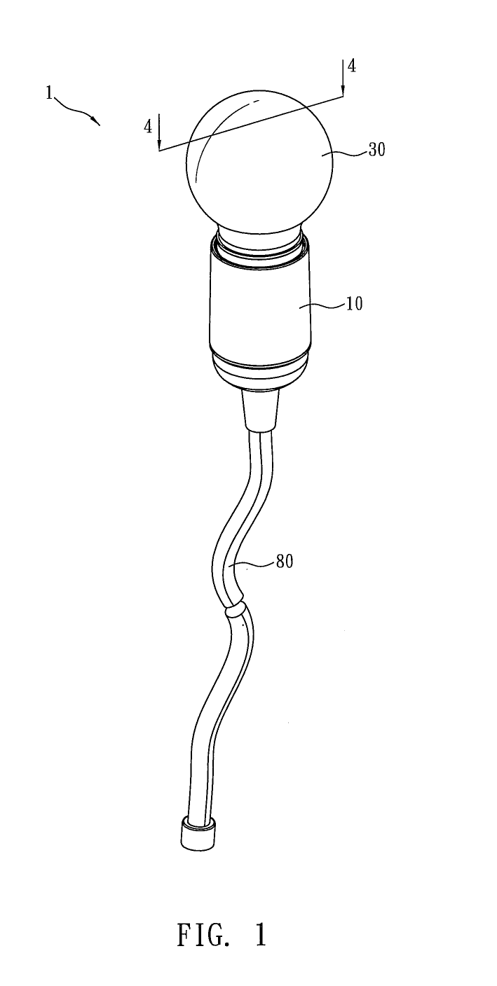

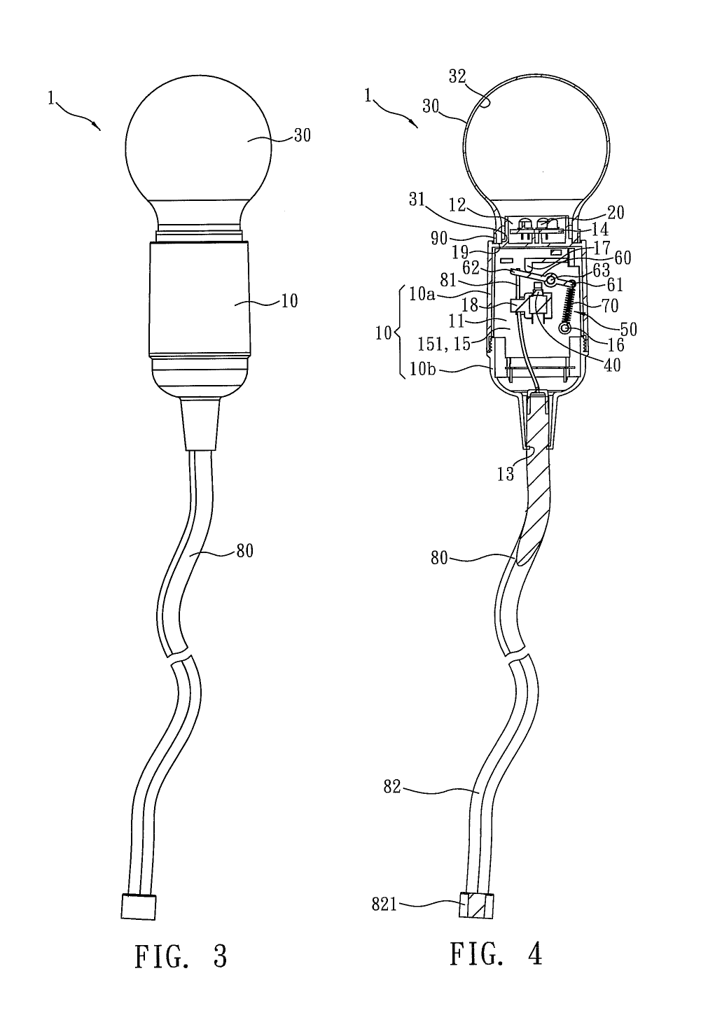

FIG. 1 through FIG. 4 shows individually the perspective, assembly, front, and cross section view of the invention. The lamp structure 1 of the invention comprises a lamp body 10, at least one illuminating element 20, a lamp shade, a switch 40, and a control structure 50.

The said lamp body 10 defines an internal cavity 11, a opening 12 on the top of the lamp body 10, therein the said opening 12 connected with the internal cavity 11, a perforated hole 13 locates at bottom of the lamp body 10, therein the perforated hole connected with the internal cavity 11, a PCB 14 attached firmly on the wall of the internal cavity near the said opening 12. Moreover, the lamp body 10 is further assembled from an upper lamp body 10a and a lower lamp body 10b, and engaged by the screw thread.

Hereby at least one illuminating element 20 comprises LED (Light Emitting Diode), which is installed on the PCB 14 and connected electrically with the PCB, for the purpose of emitting light. This embodiment comprises a plurality of illuminating elements 20, and evenly distributed on the said PCB 14. Therein at least one illuminating element 20 is powered by power source 21 for emitting light, wherein the power source 21 can be a battery and installed in the internal cavity 11 of the lamp body 10.

Hereby the lamp shade 30 comprises a opening 31 at bottom, whereby covering the aforementioned at least one illuminating element 20, further the opening 31 is engaging with the opening 12 on the top of the lamp body 10, hereof the lamp shade can be made of transparent or translucent plastic materials and formed integrally, or can form patterns or undertake foggy-surface treatment etc., for diversifying the visual effect of the invention and providing more richness of illuminating effect. The lamp shade can be spherical shape but not limited to one shape.

Hereby the switch 40 is installed in the internal cavity 11 of the lamp body 10, and is electrically connected with at least one illuminating element 20 for controlling on-off and illuminating modes (on, off, twinkling), and further demonstrates functions such as illumination and decoration. For incorporating at least one illuminating element 20 and demonstrating the effect of illumination of the said illuminating element 20, the method, for example, includes contacting the switch 40 once, and thereby executing the control on the illuminating element 20 the state of on, off, or illuminating modes, and subsequently contacting the switch 40 then will changing the illuminating modes in a given sequence, wherein the mode alternating techniques are the prior arts and will not be described in the text.

Hereby the control structure 50 comprises a pressing plate 60, which is installed in the internal cavity 11 of the lamp body 10 and couples with the switch 40, wherein pressing plate 60 comprises one termination defined as the first termination 61, and the opposing termination defined as the second termination 62, therein comprising a pivotal axis 63 between the first and second terminations such that the pressing plate 60 installed pivotally inside the internal cavity 11 of the lamp body 10; a spring object 70, which connects with the first termination 61 of the pressing plate 60 at one end, and the other end flexibly secured inside the internal cavity 11 of the lamp body 10; and a strap 80, which comprises a fixed end 81 connected with the second termination 62 of the pressing plate 60, and the opposing other end comprising a loose end 82 extending through the perforated hole 13 to the outside of the lamp body 10. The loose end 82 further comprising a holding porting for the grasp of the hands in order to pulling the strap.

This invention further enhances the functionalities of illumination or decoration, thereby not only controls the on-off and illumination modes of the illuminating element, but also adds colorful painting materials on the inner surface 32 of the lamp shade 30, or the lamp shade 30 is made of plastic material with different colors, or selecting LED's with different emitting color as illuminating element 20. The aforementioned colors can be selected in the different combinations without specific limitation and enable the lamp structure 1 generating light with different colors, thereby enhance the effect of illumination and decoration.

Moreover, there installed a supporting plate 15 in the internal cavity 11 of the lamp body 10, such that the switch 40 can be secured on one of the side surface 151.

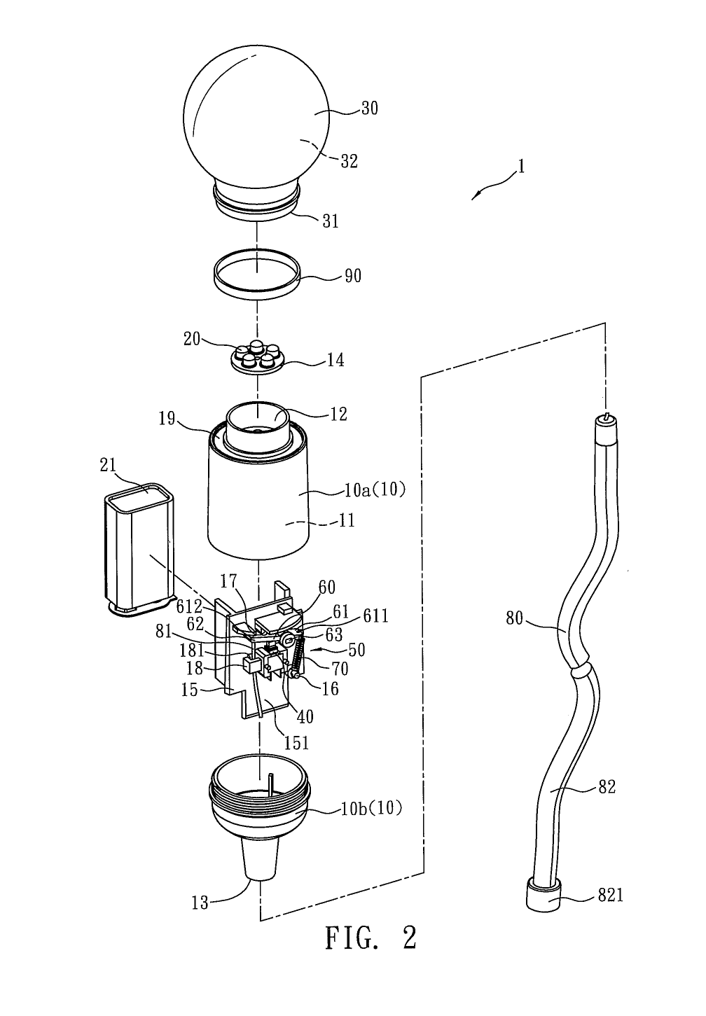

As shown in FIG. 2, there installed a first securing hole 611 on the first termination 61 of the pressing plate 60 for securing one end of the spring object 70, and a second securing hole 612 on the second termination 62 of the pressing plate 60 for securing the fixed end 81 of the strap 80.

At a proper location in the internal cavity 11 of the lamp body 10 is further installed a securing portion 16 for one end of the spring object 70 can be flexibly secured at this securing portion 16, while the other end flexibly connected with the first termination 61 of the pressing plate 60. In this embodiment, the securing portion 16 is formed integrally on the protuberance of the side surface 151 of the supporting plate 15 in the cavity 11 (as shown in FIG. 2), but not limited to the said formation, for example, is formed integrally on the surface of the internal cavity 11 (not shown in the figures), wherein the securing portion locates below the first termination 61 of the said pressing plate 60.

At a proper location in the internal cavity 11 of the lamp body 10 is further installed a stopping portion 17 for providing functionalities of stopping and securing to the pressing plate 60 when bouncing back by the recoil of the spring object and rotating counterclockwise around the pivotal axis, wherein the said stopping portion 17 can be formed integrally on the protuberance of the side surface 151 of the supporting plate 15 in the cavity 11 (as shown in FIG. 2), but not limited to the said formation, for example, is formed integrally on the surface of the internal cavity 11 (not shown in the figures), wherein the stopping portion locates above the first termination 62 of the said pressing plate 60.

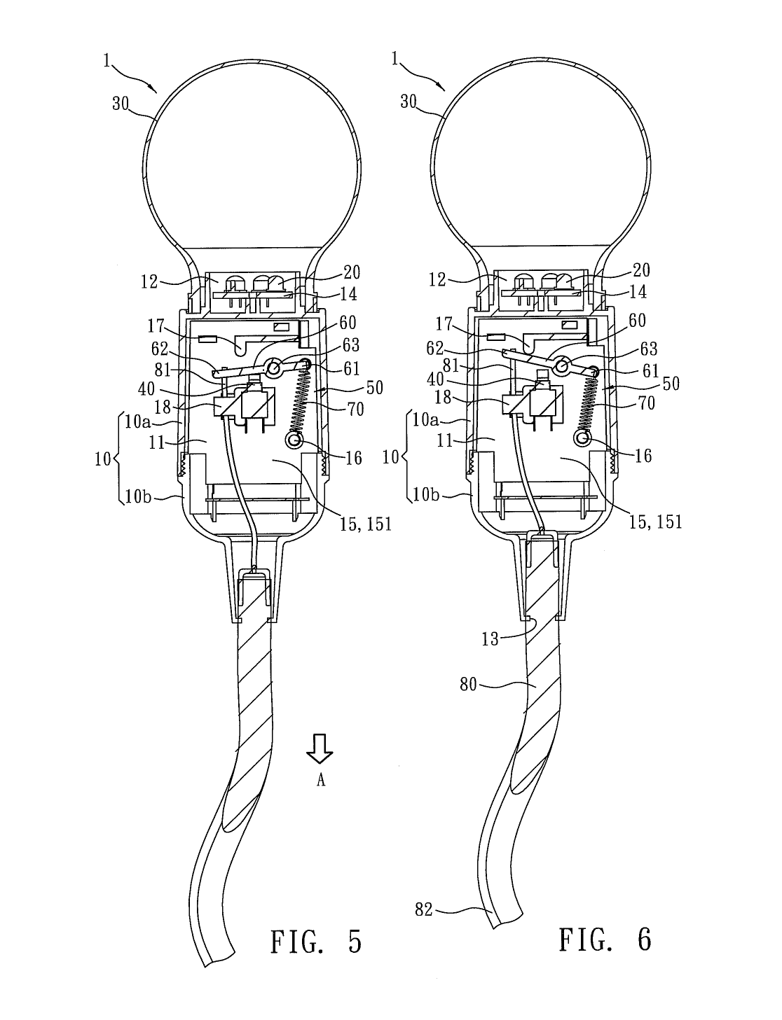

FIG. 5 shows the contacting operation of the pressing plate 60 and the switch 40 in this invention. In the state as shown in FIG. 4, the strap 80 is pulled at the loose end 82 in the direction of moving away from the bottom of the lamp body 10, thereof the pressing plate 60 is also moved and rotated around the pivotal axis 63 clockwise thereafter contacting the switch 40, and subsequently the switch is pressed and thereby controls the on-off and illuminating modes (i.e., turn-on, turn-off, and twinkling).

FIG. 6 shows the separating operation of the pressing plate 60 and the switch 40 in this invention. In the state as shown in FIG. 5, the strap 80 is released at the loose end 82, thereafter the recoil of the spring object 70 moves the pressing plate 60, which rotating around the pivotal axis 63 counterclockwise thereafter the pressing plate 60 separating from the switch 40, and subsequently returning back to the state shown in FIG. 4. Due to the fact that length of the strap 80 is longer than the distance between the second termination 62 of the pressing plate 60 and the pivotal axis 63, namely, the pivotal axis 63 supports the pressing plate 60 rotating around, therefore it can be operated by minimal external force.

FIG. 2 shows that at a proper location in the internal cavity 11 of the lamp body 10 is further installed a guiding tag 18; as the FIG. shows, the said guiding tag 18 installed on the side surface 151 of the of the supporting plate 15, therein installed a guiding hole 181 on the guiding tag 18, which providing the loose end 82 of the strap 80 penetrating through and further going through the opening 13 of the lamp body 10 and further extending to the outside of the lamp body 10, thereby making the strap preventing from obstacles caused by the internal components in the internal cavity 11 of the lamp body 10 when the strap is pulled or bouncing back after releasing.

As shown in FIG. 2 and FIG. 4, on the outside of the opening 12 of the lamp body 10 further installed a joint portion 19, and the opening 31 of the lamp shade 30 comprising a inner fringe, thereby the said joint portion 19 engaging with the inner fringe of the opening 31. The opening 31 of the lamp shade 30 is further fastened on the joint portion 19 by a ring 90, thereafter the lamp shade is tightly secured on the lamp body 10.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A lamp structure comprising:
a lamp body, which comprising an internal cavity connected with an opening on the top, a perforated hole at bottom for external connections, and a PCB (Printed Circuit Board) attached firmly on the wall of the internal cavity near the said opening;
at least an illuminating element, which is installed on the PCB and electrically connected with the PCB, thereby a power source providing the electrical power for emitting light of the said illuminating element;
a lamp shade, which comprises an opening at bottom, at least one lamp housing for illuminating element, thereon the opening coupled with the opening on the top of the lamp body;
a switch, which is installed inside the internal cavity of the lamp body, and electrically connected with at least one illuminating element for selecting the on-off and illuminating modes of the light illuminating element; and
a control structure, which comprises a pressing plate installed in the internal cavity of the lamp body in conjunction with the said switch, therein one end defined as the first termination, and the opposing end defined as the second termination, therein comprising a pivotal axis between the first and second terminations such that the pressing plate installed pivotally inside the lamp body; and
a spring object, which connects with the first termination at one end, and the other end flexibly secured inside the internal cavity of the lamp body; and
a strap, which comprises a fixed end connected with the second termination of the pressing plate, and the opposing other end comprising a loose end extending through the perforated hole to the outside of the lamp body;
thereof when the strap is pulled outward against the lamp body, subsequently the pressing plate rotated pivotally around the pivotal axis clockwise, thereafter contacting the switch and selecting the on-off and illuminating modes of the light illuminating element;
thereof when the strap is released, the recoil of the spring object making the pressing plate rotated counterclockwise and separating with the switch.

2. A lamp structure as claimed in claim 1, wherein the lamp shade is made of plastic materials.

3. A lamp structure as claimed in claim 1, wherein the lamp shade is made of transparent plastic materials.

4. A lamp structure as claimed in claim 1, wherein the lamp shade is made of translucent plastic materials.

5. A lamp structure as claimed in claim 1, wherein different colorful painting materials are selectively painted on the inner surface of the lamp shade.

6. A lamp structure as claimed in claim 1, wherein the illuminating element comprises at least on LED.

7. A lamp structure as claimed in claim 1, wherein the lamp structure further comprises a power source for supplying the illuminating element emitting light.

8. A lamp structure as claimed in claim 7, wherein the power supply comprises battery and installed in the internal cavity of the lamp body

9. A lamp structure as claimed in claim 1, wherein the spring object comprises a elastic spring.

10. A lamp structure as claimed in claim 1, wherein the strap comprises a nylon strap

11. A lamp structure as claimed in claim 1, wherein the loose end of the said strap comprises a holding portion for the grasp of hand.

12. A lamp structure as claimed in claim 1, wherein the lamp body is further assembled from an upper lamp body and a lower lamp body, and engaged by the screw thread.

13. A lamp structure as claimed in claim 1, wherein a first securing hole is installed on the first termination of the pressing plate or securing one end of the spring object , and a second securing hole is installed on the second termination of the pressing plate for securing the fixed end of the strap.

14. A lamp structure as claimed in claim 1, a supporting plate is installed in the internal cavity of the lamp body, such that the switch can be secured on, and the said supporting plate provides the pivotal axis of the pressing plate to pivotally connected with.

15. A lamp structure as claimed in claim 14, wherein a securing portion is formed integrally on the protuberance of the side surface of the supporting plate and locates below the first termination of the said pressing plate for flexibly securing one end of the spring object.

16. A lamp structure as claimed in claim 14, wherein a stopping portion is formed integrally on the protuberance of the side surface of the supporting plate and locates above the first termination of the said pressing plate, therein for providing functionalities of stopping and securing to the pressing plate when bouncing back by the recoil and rotating counterclockwise around the pivotal axis.

17. A lamp structure as claimed in claim 14, wherein a guiding tag is installed on the side surface of the of the supporting plate, therein installed a guiding hole on the guiding tag for providing the loose end of the strap penetrating through and further going through the opening 13 of the lamp body and further extending to the outside of the lamp body.

18. A lamp structure as claimed in claim 14, wherein the lamp shade comprises a inner fringe and on the outside of the opening of the lamp body further installed a joint portion, thereby the said joint portion engaging with the inner fringe of the opening thereat further fastened on the joint portion by a ring, thereafter the lamp shade is tightly secured on the lamp body.
